(19) United States
(12) Patent Application Publication
(10) Pub. No.: US 2026/0106946 A1
(43) Pub. Date: Apr. 16, 2026

(54) IMAGE FORMING APPARATUS AND STORAGE MEDIUM

(71) Applicant: Konica Minolta, Inc., Tokyo (JP)

(72) Inventor: Takefumi NISHIO, Tokyo (JP)

(21) Appl. No.: 19/358,484

(22) Filed: Oct. 15, 2025

(30) Foreign Application Priority Data
Oct. 16, 2024 (JP) 2024-180540

(51) Int. Cl. H04N 1/58; H04N 1/00

(52) U.S. Cl. CPC H04N 1/58; H04N 1/00652; H04N 2201/0081

(57) ABSTRACT

An image forming apparatus including: an image former that continuously forms images in a plurality of colors on sheets of paper by an intermediate transfer method; a reader that reads an image that has been formed on a sheet of the paper by the image former; and a hardware processor that corrects color misregistration in an image to be formed on a sheet of the paper by the image former. The hardware processor corrects the color misregistration based on a reading result obtained by reading, by the reader, an image that has been formed on at least one of a subsequent sheet among the sheets on which the images have been continuously formed by the image former, the subsequent sheet being subsequent to a first sheet among the sheets.

### CROSS REFERENCE TO RELATED APPLICATIONS

The present invention claims priority under 35 U.S.C. § 119 to Japanese Patent Application No. 2024-180540 filed on Oct. 16, 2024, the entire contents of which is being incorporated herein by reference.

### BACKGROUND OF THE INVENTION

### Technical Field

The present disclosure relates to an image forming apparatus and a storage medium.

### Description of Related Art

There are increasing fields in the production printing market where there is a great need for thick paper. Therefore, in recent years, with increase of needs, color misregistration in a sheet feeding direction in which thick paper is more likely to be influenced by printing in electrophotographic method using intermediate transfer has become apparent as a problem.

In this connection, Japanese Unexamined Patent Publication No. 2022-071703 discloses an image forming apparatus that reads a test chart formed on a sheet and controls the speed of a roller in a transfer section on the basis of the read data, to correct the partial magnification of an image formed on the sheet.

### SUMMARY OF THE INVENTION

However, in a case where images are continuously formed on a plurality of sheets in the image forming apparatus, since no preceding sheet exists for the first sheet, color misregistration due to the preceding sheet does not occur. On the other hand, color misregistration due to the preceding sheet occurs in at least one of the subsequent sheets to the first sheet (that is, second sheet and its subsequent sheets) (hereinafter, simply referred to as the subsequent sheets). Therefore, the amount of color misregistration occurring on the first sheet is smaller than those occurring on at least one of the subsequent sheets. Therefore, when the color misregistration correction is performed based on the image formed on the first sheet, the color misregistration correction for at least one of the subsequent sheets may be insufficient.

It is an object of the present disclosure to provide an image forming apparatus and a program that can accurately correct color misregistration in an image formed on a sheet.

To achieve at least one of the abovementioned objects, according to an aspect of the present invention, image forming apparatus reflecting one aspect of the present invention comprises:
an image former that continuously forms images in a plurality of colors on sheets of paper by an intermediate transfer method;
a reader that reads an image that has been formed on a sheet of the paper by the image former; and
a hardware processor that corrects color misregistration in an image to be formed on a sheet of the paper by the image former, wherein
the hardware processor corrects the color misregistration based on a reading result obtained by reading, by the reader, an image that has been formed on at least one of a subsequent sheet among the sheets on which the images have been continuously formed by the image former, the subsequent sheet being subsequent to a first sheet among the sheets.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a front view illustrating a schematic configuration of an image forming apparatus according to the present embodiment;

FIG. 2 is a functional block diagram illustrating a control structure of the image forming apparatus according to the present embodiment;

FIG. 3 is a diagram illustrating a case where a sheet conveyance speed in a fixing section is higher than a sheet conveyance speed in a transfer section;

FIG. 4 is a diagram illustrating a case where the sheet conveyance speed in the fixing section is lower than the sheet conveyance speed in the transfer section;

FIG. 5 is a diagram illustrating the image forming section at a timing immediately before the leading end of the first sheet enters the fixing nip part;

FIG. 6 is a diagram illustrating an area of a first sheet where color misregistration occurs;

FIG. 7 is a diagram illustrating the image forming section at a timing when a trailing edge of a first sheet exits from the transfer section;

FIG. 8 is a diagram illustrating an area where color misregistration occurs on the at least one of the subsequent sheets; and

FIG. 9 is a flowchart illustrating a flow of color misregistration correction processing.

### DETAILED DESCRIPTION

Hereinafter, one or more embodiments of the present invention will be described with reference to the drawings. However, the scope of the invention is not limited to the disclosed embodiments.

Hereinafter, embodiment of the present disclosure will be described in detail with reference to the drawings.

### 1 Configuration of Image Forming Apparatus

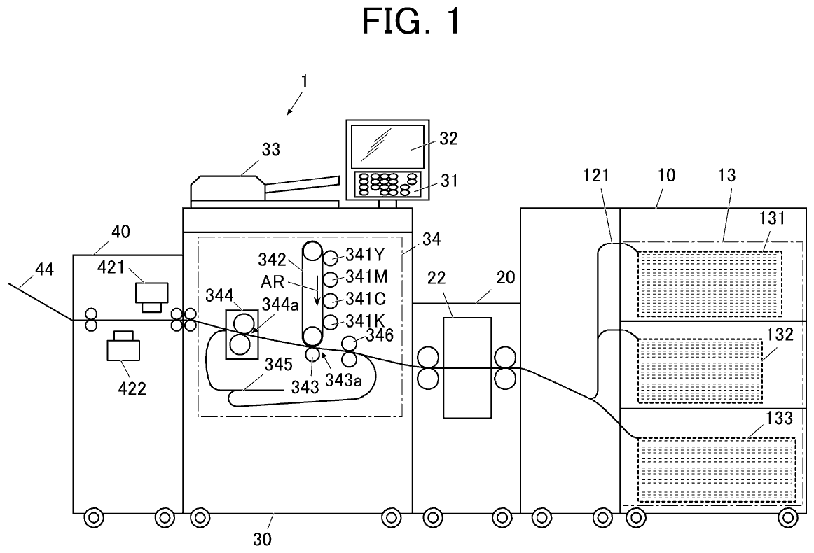

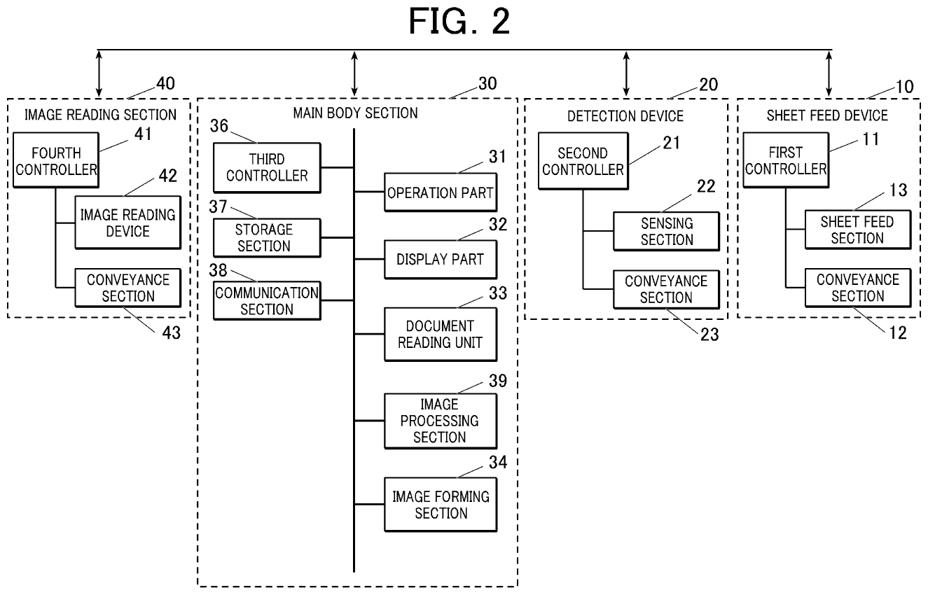

As shown in FIG. 1 and FIG. 2, the image forming apparatus 1 according to the present embodiment includes a sheet feed device 10, a detection device 20, a main body section 30, and an image reading device 40.

In the image forming apparatus 1, the sheet feed device 10, the detection device 20, the main body section 30, and the image reading device 40 are arranged in this order from the upstream side along the sheet conveyance direction.

### 1-1. Configuration of Sheet Feed Device

The sheet feed device 10 includes a controller 11, a conveyance section 12, and a sheet feed section 13.

The first controller 11 includes a central processing unit (CPU), a ROM (Read Only Memory), and a RAM (Random Access Memory) and the like.

The CPU of the first controller 11 reads a program stored in the ROM, develops the program in the RAM, and integrally controls each unit of the sheet feed device 10 according to the developed program.

For example, the controller 11 conveys a sheet from any of the sheet feed trays 131 to 133 of the sheet feed section 13 to the detection device 20 in accordance with a print job.

The conveyance section 12 includes a conveyance route 121 connecting from the sheet feed section 13 to the detection device 20 and conveys a sheet.

The sheet feed section 13 includes sheet feed trays 131 to 133 that store sheets by predetermined paper type, size, and the like. For example, the sheet feed tray 131 stores sheets having a larger size than the sheets stored in the sheet feed tray 132. The sheet feed tray 133 stores sheets having a greater sheet thickness than the sheets stored in the sheet feed trays 131 and 132.

### 1-2. Configuration of Detection Device

The detection device 20 is located on the downstream side of the sheet feed device 10 in the sheet conveyance direction and on the upstream side of the main body section 30 in the sheet conveyance direction.

The detection device 20 detects a physical property of the sheet conveyed from the sheet feed device 10 and outputs a physical property value which is an obtained detection result to a third controller 36 (hardware processor) which will be described later. The physical property value of the sheet is attribute information of the sheet.

The detection device 20 detects values (physical property values) relating to physical properties of a plurality of types of sheets including basis weight, stiffness, moisture content, surface properties, and the like of the sheets. The physical property value may be information that can be converted (transformed) into a physical property.

The detection device 20 includes a second controller 21, a sensing section 22 (sensor), and a conveyance section 23.

The controller 21 includes a CPU, a ROM, and a RAM.

The CPU of the second controller 21 reads a program stored in the ROM, develops the program in the RAM, and integrally controls each unit of the detection device 20 according to the developed program.

For example, the second controller 21 causes the sensing section 22 to detect the sheet conveyed from the sheet feed device 10 and outputs the obtained physical property value to the third controller 36. Next, the secondary controller 21 causes the conveyance section 23 to convey the detected sheet to the main body section 30.

The sensing section 22 detects a physical property value in a sheet.

The sensing section 22 includes sensors that detect the basis weight, stiffness, moisture content, surface properties, and the like of a sheet as physical property values of the sheet.

For example, a sensor that detects the basis weight of a sheet includes a light emitting section and a light receiving section and measures the basis weight based on the amount of attenuation of light transmitted through the sheet. The sensing section 22 outputs the basis weight as the physical property value to the second controller 21.

The sensor that performs detection of the stiffness of the sheet detects a physical property corresponding to the stiffness of the sheet. For example, when a sheet is conveyed in a curved conveyance path, the sensor mechanically measures, in the curved conveyance path, the force with which the sheet presses one of the outer guide plates constituting the conveyance path or the amount of displacement of the outer guide plate. The sensing section 22 outputs, to the second controller 21, the stiffness as a physical property value based on the force applied by the sheet or the amount of displacement.

The sensor that detects the moisture content of the sheet optically detects, for example, a light absorption amount of an OH group of a near-infrared method. The sensor irradiates a sheet with light having a predetermined wavelength in the near-infrared region and detects the amount of light absorption using a property in which the absorptance of light changes in accordance with the moisture content of the sheet. As another example, the sensor may measure the moisture content by measuring a change in the amount of light of a reflected component inside the sheet using reflected light separated by a filter. The sensing section 22 outputs the moisture content as the physical property value to the second controller 21.

A sensor that detects the surface properties (smoothness, smoothness) of the sheet includes, for example, a reflection sensor that outputs the intensities and/or the intensity ratio of specular reflection light and scattered reflection light of the light applied to the sheet. The sensor measures surface properties based on the intensity ratio. The sensing section 22 outputs the surface properties as the physical property value to the second controller 21.

The sensing section 22 may include, in addition to the above-described sensors, a sensor that detects the specific gravity, the conductivity, and the like of the sheet.

The conveyance section 23 includes a plurality of roller pairs, and conveys the sheet conveyed from the sheet feed device 10 to the sensing section 22.

Next, the conveyance section 23 conveys the sheet detected by the sensing section 22 to the main body section 30.

### 1-3. Configuration of Main Body Section

The main body section 30 is located on the downstream side of the detection device 20 in the sheet conveyance direction and on the upstream side of the image reading device 40 in the sheet conveyance direction.

The main body section 30 forms a color image by an electrophotographic method based on image data obtained by reading an image from a document or job image data of a print job received from an external device (not shown). Next, the main body section 30 conveys the sheet on which the image formation has been performed to the image reading device 40.

As shown in FIG. 1 and FIG. 2, the main body section 30 includes an operation part 31, a display part 32, a document reading unit 33, an image forming section 34 (image former), a third controller 36, a storage section 37, a communication section 38, and an image processing section 39.

The operation part 31 includes a touch screen formed so as to cover the display screen of the display part 32 and various operation buttons such as numeric buttons and a start button.

The operation part 31 outputs an operation signal based on a user operation to the third controller 36.

The display part 32 includes a liquid crystal display (LCD) or the like.

The display part 32 displays various screens according to an instruction of a display signal input from the third controller 36.

The document reading unit 33 includes an ADF (Auto Document Feeder), scanner, and the like.

The document reading unit 33 outputs image data obtained by reading the image of the document to the third controller 36.

The image forming section 34 forms an image by an intermediate transfer method on the sheet conveyed from the detection device 20, based on the image data subjected to the image processing by the image processing section 39. In the present embodiment, the sheet is a flat cut sheet.

The image forming section 34 includes photosensitive drums 341Y, 341M, 341C, and 341K corresponding to the colors yellow (Y), magenta (M), cyan (C), and black (K), an intermediate transfer belt 342, a secondary transfer roller 343, a fixing section 344, a reverse path 345, a registration section 346, and the like.

The photosensitive drum 341Y, 341M, 341C, and 341K are arranged in series in this order along the traveling direction A R from the upstream in the traveling direction A R of the intermediate transfer belt 342.

The image forming section 34 uniformly charges the photosensitive drum 341Y and then scans and exposes the photosensitive drum 341Y with a laser beam based on image data of yellow color to form an electrostatic latent image. Next, the image forming section 34 makes a yellow toner adhere to the electrostatic latent image on the photosensitive drum 341Y to perform developing.

Since the photosensitive drums 341M, 341C, and 341K are similar to the photosensitive drum 341Y except that the colors to be handled are different, the description thereof will be omitted.

The image forming section 34 sequentially transfers the toner images in the respective colors formed on the photosensitive drums 341Y, 341M, 341C, and 341K onto the rotating intermediate transfer belt 342 (primary transfer). That is, the image forming section 34 forms a color toner image in which toner images of four colors are superimposed on the intermediate transfer belt 342.

The image forming section 34 collectively transfers the color toner image on the intermediate transfer belt 342 onto a sheet by the secondary transfer roller 343 (secondary transfer). A transfer nip portion formed by the intermediate transfer belt 342 and the secondary transfer roller 343 is a transfer section 343a.

The fixing section 344 includes a heating roller that heats the sheet on which the toner image has been transferred, and a pressure roller that presses the sheet.

The fixing section 344 sandwiches the sheet with a fixing nip part 344a formed by a heating roller and a pressure roller and fixes the color toner image on the sheet by heating and pressurizing.

In the case of single-sided printing in which an image is formed on one side of a sheet in the main body section 30, the controller 36 conveys the sheet from the fixing section 344 to the image reading device 40.

On the other hand, in double-sided printing in which images are formed on both sides of a sheet, the third controller 36 conveys the sheet from the fixing section 344 to a reverse path 345 and reverses the side of the sheet. Next, the third controller 36 feeds the sheet again to the upstream side of the registration section 346 in the sheet conveyance direction.

The registration section 346 includes a registration roller and conveys the sheet to the transfer section 343a.

The registration section 346 corrects the inclination of the sheet conveyed from the detection device 20 and adjusts the conveyance timing of the sheet.

The third controller 36 includes a CPU, a RAM, and a ROM.

The CPU of the third controller 36 reads various program stored in the ROM and develops them in the RAM. The third controller 36 integrally controls the operation of the main body section 30 in cooperation with various programs expanded in the RAM.

The storage section 37 is a nonvolatile storage device such as a hard disk drive (HDD) or a semiconductor memory that stores various types of data such as programs and image data.

The storage section 37 stores data such as program data and various types of setting data in a manner readable and writable by the third controller 36.

The storage section 37 stores the sheet feed trays 131 to 133 and information on the basis weight, size, paper type, and the like of the sheets stored therein in association with each other.

The communication section 38 includes a communication control card such as a local area network (LAN) card.

The communication section 38 is connected to a communication network such as a LAN or a wide area network (WAN), and transmits The image forming apparatus transmits and receives various data to and from an external device (e.g., a computer).

The image processing section 39 performs necessary image processing on the image data stored in the storage section 37, the image data obtained by reading an image from a document by the document reading unit 33, the image data input from an external device, and the like. Next, the image processing section 39 transmits the image data after the image processing to the image forming section 34.

The image processing includes gradation processing, halftone processing, color conversion processing, and the like. The gradation processing is processing for converting the gradation value of each pixel of image data into a gradation value corrected such that the gradation of the image formed on a sheet matches the target gradation. The halftone processing is error diffusion processing, screen processing using a systematic dither method, or the like. The color conversion processing is processing for converting each gradation value of RGB into each gradation value of CMYK.

### 1-4. Configuration of Image Reading Device

The image reading device 40 is positioned on the downstream side of the main body section 30 in the sheet conveying direction.

The image reading device 40 reads the sheet conveyed from the main body section 30, and outputs data of the obtained read image to the third controller 36.

The image reading device 40 includes a fourth controller 41, an image reading section 42, a conveyance section 43, and a sheet ejection tray 44.

The fourth controller 41 includes a CPU, a ROM, and a RAM.

The CPU of the fourth controller 41 reads a program stored in the ROM, develops the program in the RAM, and integrally controls each unit of the image reading device 40 according to the developed program.

For example, the fourth controller 41 causes the image reading section 42 to read a sheet conveyed from the main body section 30, and outputs data of the obtained read image to the third controller 36. Next, the fourth controller 41 ejects the read sheet to the sheet ejection tray 44 by the conveyance section 43.

The image reading section 42 includes reading sections 421 and 422.

The reading section 421 reads an image on one side of the sheet and acquires read image data.

The reading section 422 reads an image on the other side of the sheet and acquires read image data.

The reading sections 421 and 422 each include a line image sensor and an illumination section.

In the image sensor, a plurality of imaging elements (e.g., charge coupled devices (CCDs)) that photoelectrically convert incident light for each pixel are arranged in a one-dimensional array in the width direction of the sheet. The width direction of the sheet is orthogonal to the sheet conveyance direction.

The illumination section irradiates the sheet with light in order to enable appropriate reading of the sheet. The illumination section is composed of, for example, an LED, a diffusion member which uniformly spreads the light emission over the reading range, and the like.

The reading sections 421 and 422 may include a contact image sensor (CIS) in which a line image sensor and an illumination unit are integrated, a two-dimensional area sensor and an illumination unit, or the like.

The image reading section 42 reads one of the upper surfaces, the lower surface, and both surfaces of the sheet conveyed from the main body section 30 by the reading sections 421 and 422. Next, the image reading section 42 outputs the generated read image as a reading result to the fourth controller 41.

The image reading section 42 may include a background member serving as the background of the sheet image when the sheet is read by the line image sensor or the like.

The conveyance section 43 includes a plurality of roller pairs, and conveys the sheet conveyed from the main body section 30 to the image reading section 42. Next, under the control of the controller 41, the conveyance section 43 ejects the sheet read by the image reading section 42 to the sheet ejection tray 44.

In the present embodiment, the third controller 36 of the main body section 30 integrally controls the entire image forming apparatus 1, but the present invention is not limited thereto. The second controller 21 of the detection device 20 or the fourth controller 41 of the image reading device 40 may be configured to comprehensively control the entire image forming apparatus 1.

### 2 Color Misregistration Due to Speed Difference Between Fixing Speed and Transfer Speed

Next, color misregistration due to a speed difference between a sheet conveyance speed (fixing speed) in the fixing section 344 and a sheet conveyance speed (transfer speed) in the transfer section 343a will be described.

The color misregistration according to the present embodiment is color misregistration between at least two colors in an image formed on a sheet.

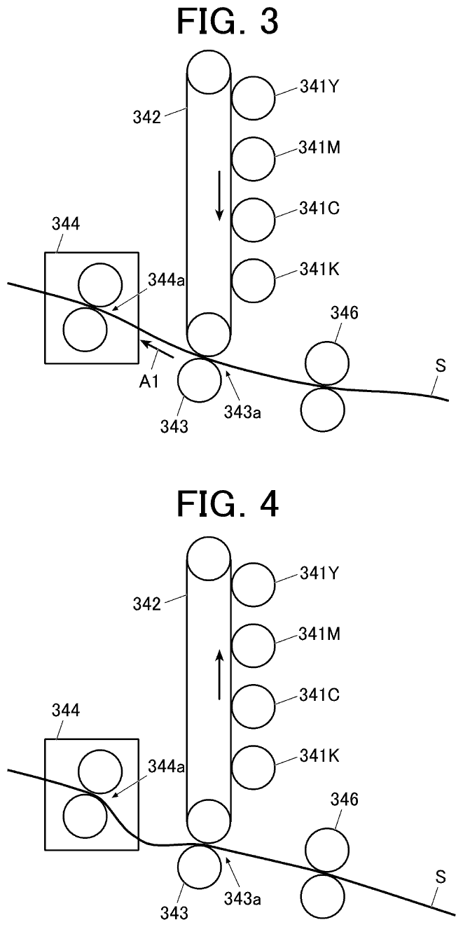

FIG. 3 illustrates a case where the fixing speed is higher than the transfer speed.

In this case, the sheet S is pulled in a direction of A1 illustrated in FIG. 3 by the fixing nip portion 344a formed by the heating roller and the pressure roller of the fixing section 344. Thus, the speed of the intermediate transfer belt 342 becomes higher than a normal value at which color misregistration does not occur, so that the primary transfer positions shift and color misregistration occurs in the image formed on the sheet S.

FIG. 4 illustrates a case where the fixing speed is lower than the transfer speed.

In this case, the sheet S becomes slack between the fixing section 344 and the transfer section 343a, and the reaction to the slack causes the speed of the intermediate transfer belt 342 to become slower than a normal speed at which color misregistration does not occur. As a result, the position of primary transfer is shifted, and color misregistration occurs in the image formed on the sheet S. When the sheet S is thick paper, the reaction force against the slack is larger than that in the case of thin paper, and therefore, the speed of the intermediate transfer belt 342 tends to decrease. The thick paper is, for example, a sheet having a thickness equal to or larger than a predetermined value or a basis weight equal to or larger than a predetermined value.

### 3 Color misregistration in Continuous Image Formation

Next, color misregistration when images are continuously formed on a plurality of sheets in the main body section 30 will be described.

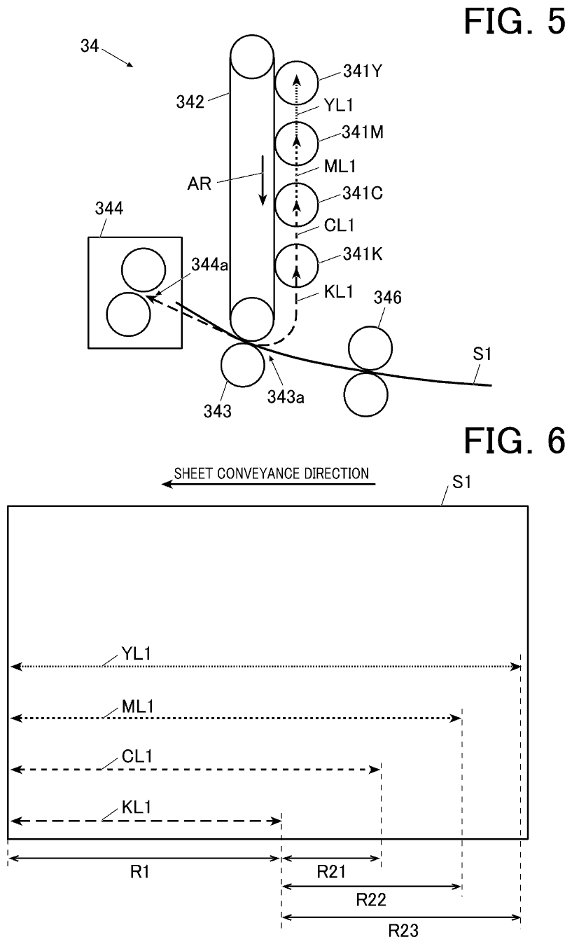

FIG. 5 illustrates the image forming section 34 at a timing immediately before the leading end of the first sheet S1 plunges into the fixing nip portion 344a.

As illustrated in FIG. 5, the photosensitive drum 341Y, 341M, 341C, and 341K are disposed in series along a running direction AR of the intermediate transfer belt 342. Therefore, distances from the fixing nip portion 344a to the respective photosensitive drums 341Y, 341M, 341C, and 341K via the transfer section 343a are different. To be specific, the distances are shorter in the order of the distance KL1, distance CL1, distance ML1, and distance YL1. The distance KL1 is a distance from the fixing nip part 344a to the photosensitive drum 341K via the transfer section 343a. The distance CL1 is a distance from the fixing nip part 344a to the photosensitive drum 341C via the transfer section 343a. The distance ML1 is a distance from the fixing nip part 344a to the photosensitive drum 341M via the transfer section 343a. The distance YL1 is a distance from the fixing nip part 344a to the photosensitive drum 341Y via the transfer section 343a.

When the leading end of the first sheet S1 enters the fixing nip part 344a, the intermediate transfer belt 342 is influenced by the fixing speed via the sheet S1, so that the speed of the intermediate transfer belt 342 changes. Therefore, color misregistration due to the speed difference between the fixing speed and the transfer speed may occur in the image formed on the first sheet S1.

An area R1 in the sheet S1 for the first sheet illustrated in FIG. 6 is an area from the leading end of the sheet S1 to a distance KL1. The area R1 is an area where the black (K) toner image is primarily transferred by the time the leading end of the sheet S1 enters the fixing nip portion 344a. In the area R1, the sheet S1 is not pinched by the fixing nip portion 344a, and therefore, is not influenced by the fixing speed. Therefore, color misregistration due to a speed difference between the fixing speed and the transfer speed is less likely to occur in the area R1.

On the other hand, an area of the sheet S1 on the rear end side relative to the area R1 is an area to which the black (K) toner image is primarily transferred after the leading end of the sheet S1 enters the fixing nip part 344a. Therefore, color misregistration between black (K) and the other colors due to a speed difference between the fixing speed and the transfer speed may occur in an area of the sheet S1 closer to the rear end than the area R1.

To be more specific, the area R21 in the sheet S1 is an area affected by the difference between the distances KL1 and CL1. In the image formed on the sheet S1 in the area R21, color misregistration tends to occur between black (K) and cyan (C) due to a speed difference between the fixing speed and the transfer speed caused by entry of the sheet S1 into the fixing nip 344a.

The area R22 in the sheet S1 is an area affected by the difference between the distances KL1 and ML1. In the image formed on the sheet S1 in the area R22, color misregistration between black (K) and magenta (M) is likely to occur due to a speed difference between the fixing speed and the transfer speed caused by the sheet S1 entering the fixing nip portion 344a.

The area R23 in the sheet S1 is an area affected by the difference between the distances KL1 and YL1. In the area R23, in the image formed on the sheet S1, a color misregistration between black (K) and yellow (Y) is likely to occur due to the speed difference between the fixing speed and the transfer speed caused by the sheet S1 entering the fixing nip portion 344a.

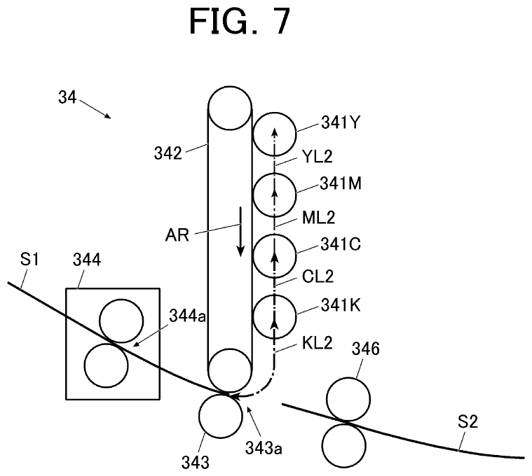

FIG. 7 illustrates the image forming section 34 at a timing when the trailing edge of the first sheet S1 exits from the transfer section 343a. At this timing, the second sheet S2 is in a state of being nipped by the registration section 346.

As shown in FIG. 7, the distances from the transfer section 343a to the respective photosensitive drums 341Y, 341M, 341C, and 341K are different. To be specific, the distances are shorter in the order of the distance KL2, distance CL2, distance ML2, and distance YL2. The distance KL2 is a distance from the transfer section 343a to the photosensitive drum 341K. The distance CL2 is a distance from the transfer section 343a to the photosensitive drum 341C. The distance ML2 is a distance from the transfer section 343a to the photosensitive drum 341M. The distance YL2 is a distance from the transfer section 343a to the photosensitive drum 341Y.

When the rear end of the first sheet S1 comes out of the transfer section 343a, the intermediate transfer belt 342 is no longer influenced by the fixing speed via the sheet S1, so that the speed of the intermediate transfer belt 342 changes. Therefore, in the image formed on the second sheet S2, color misregistration may occur due to the speed difference between the fixing speed and the transfer speed that occurs when the rear end of the first sheet S1 comes out of the transfer section 343.

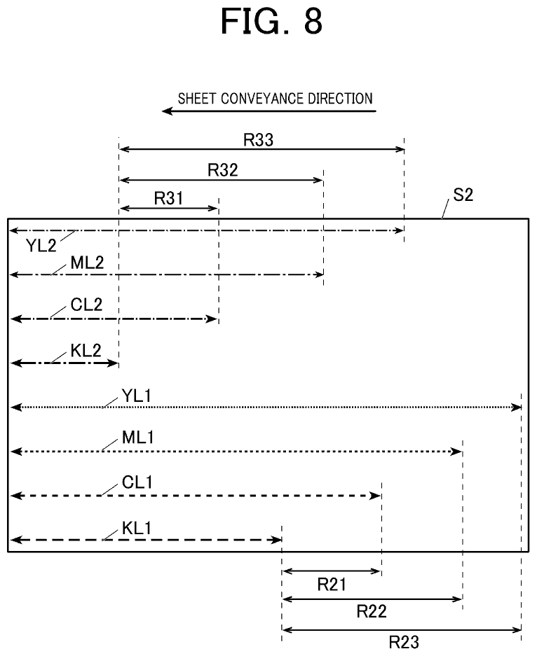

An area R31 on the second sheet S2 illustrated in FIG. 8 is an area influenced by the difference between the distances KL2 and CL2. In the area R31, in the image formed on the sheet S2, color misregistration between black (K) and cyan (C) tends to occur due to the speed difference between the fixing speed and the transfer speed, which occurs when the rear end of the first sheet S1 comes out of the transfer section 343a.

The area R32 on the sheet S2 is an area influenced by the difference between the distances KL2 and ML2. In the area R32, in the image formed on the sheet S2, color misregistration between black (K) and magenta (M) tends to occur due to the speed difference between the fixing speed and the transfer speed, which occurs when the rear end of the first sheet S1 comes out of the transfer section 343a.

The area R33 on the sheet S2 is an area affected by the difference between the distances KL2 and YL2. In the area R33, in the image formed on the sheet S2, color misregistration between black (K) and yellow (Y) is likely to occur due to the speed difference between the fixing speed and the transfer speed caused by the trailing end of the first sheet S1 exiting from the transfer section 343a.

At the S2 of the second sheet, furthermore, similarly to the first sheet S1, in the areas R21 to R23, color misregistration between black (K) and the other colors may occur due to the speed difference between the fixing speed and the transfer speed that occurs when the S2 of the sheet enters the fixing nip part 344a.

As described above, in the second sheet S2, the area in which the color misregistration can occur is larger than that in the first sheet S1. Similarly to the second sheet S2, the area where the color misregistration can occur is larger in at least one of the third and its subsequent sheets than in the first sheet S1. Therefore, in a case where images are continuously formed on a plurality of sheets, the image forming apparatus 1 of the present embodiment corrects color misregistration in images formed on the sheets by the image forming section 34 based on the color misregistration amount on the at least one of the subsequent sheets.

### 3. Operation of Image Forming Apparatus

Next, color misregistration correction processing that is executed before a print job is executed in the image forming apparatus 1 will be described.

The third controller 36 of the image forming apparatus 1 cooperates with the program stored in the storage section 37 to execute the color misregistration correction processing.

The third controller 36 executes the color misregistration correction processing, for example, when the main body section 30 receives job information of a print job from an external device or the like via the communication section 38. The external device is, for example, a computer.

The third controller 36 corrects color misregistration in an image formed on a sheet by the image forming section 34 by executing the color misregistration correction processing. The third controller 36 functions as a controller.

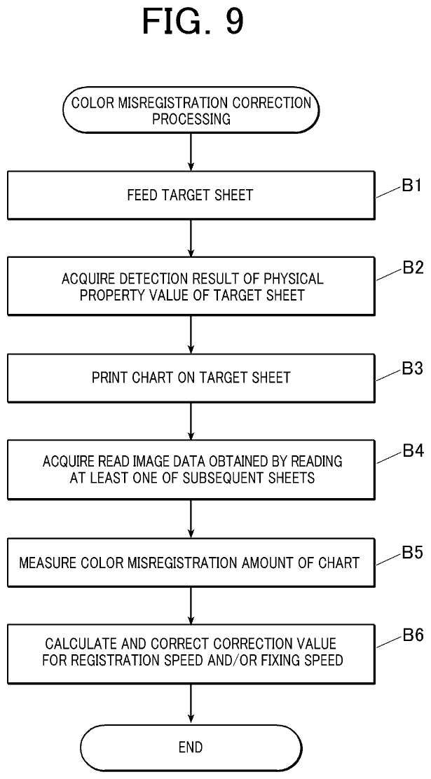

FIG. 9 shows a flowchart of the color misregistration correction processing.

### Color Misregistration Correction Processing

Based on the received job information, the third controller 36 continuously feeds a plurality of target sheets of the print job from the sheet feed device 10 (step B1).

Next, the third controller 36 causes the detection device 20 to detect the target sheet, thereby acquiring a detection result of physical property values of the target sheet (step B2).

Next, the third controller 36 controls the image forming section 34 to continuously form the patterns on the plurality of target sheets (step B3). The chart is used to measure a color misregistration amount between at least two colors of yellow (Y), magenta (M), cyan (C), and black (K) in an image formed by the image forming section 34.

Next, the third controller 36 causes the image reading device 40 to read the chart formed on the sheet and acquires a read image data that is a reading result (step B4).

In step B4, the third controller 36 may cause the image reading device 40 to read all the sheets on which the charts are formed and acquire the read image data of all the sheets.

Alternatively, in step B4, the third controller 36 may cause the image reading device 40 to read at least one of the subsequent sheets of the plurality of sheets on which the charts are formed and acquire the read image data of the at least one of the subsequent sheets.

Next, the third controller 36 measures the amount of color misregistration of the charts formed on the at least one of the subsequent sheets on the basis of the read image data of the at least one of the subsequent sheets acquired in step B4 (step B5).

In step B5, the third controller 36 may measure, as the color misregistration amount, each of the color misregistration amounts between the respective colors, or measure an integral value, an average value, a maximum value, a median value, a mode value, or the like of the color misregistration amounts between the respective colors.

Next, the third controller 36 calculates and corrects correction values for the registration speed and/or the fixing speed in the image formation process by the main body section 30, based on the detection result of the physical property value of the target sheet acquired in step B2 and the color misregistration amount measured in step B5 (step B6), and ends the color misregistration correction processing.

The registration speed is a sheet conveyance speed in the registration section 346.

In step B6, the third controller 36 corrects the registration speed and/or the fixing speed so that the color misregistration amount measured in step B5 becomes equal to or less than a threshold value.

### 4 Others

The image forming apparatus 1 may interrupt the print job during execution of the print job, then execute the color misregistration correction processing, and resume the print job after completion of the color misregistration correction processing.

The sensing section that detects the physical property value of the target sheet in step B2 of the color misregistration correction processing may be provided in the sheet feed trays 131 to 133, respectively.

The third controller 36 of the image forming apparatus 1 may omit step B2 of the color misregistration correction processing. In this case, in step B6, the third controller 36 calculates and corrects correction value for the registration speed and/or the fixing speed on the basis of the color misregistration amount measured in step B5.

### 5 Effects

As described above, the image forming apparatus 1 according to the present embodiment includes the image forming section 34 that continuously forms images in a plurality of colors on a sheet by an intermediate transfer method.

The image forming apparatus 1 according to the present embodiment includes a reading section (image reading section 42) (reader) that reads an image formed on a sheet by the image forming section 34.

The image forming apparatus 1 according to the present embodiment includes a controller (third controller 36) that corrects color misregistration in an image formed on a sheet by the image forming section 34.

The controller corrects the color misregistration on the basis of a reading result obtained by reading, by the reading section, the images formed on the at least one of the subsequent sheets among the sheets on which the images are continuously formed by the image forming section 34.

Therefore, when images are continuously formed on a plurality of sheets in the image forming apparatus, although the amount of color misregistration occurring on the first sheet is smaller than that occurring on the at least one of the subsequent sheets, color misregistration correction can be sufficiently performed on the at least one of the subsequent sheets by performing color misregistration correction based on the images formed on the at least one of the subsequent sheets.

Thus, the color misregistration in the image formed on the sheet can be corrected with high accuracy.

In the image forming apparatus 1 according to the present embodiment, the image forming section 34 includes a registration unit 346 that conveys a sheet to a transfer section 343a that transfers an image to the sheet, and a fixing section 344 that fixes the image to the sheet.

The controller (third controller 36) adjusts at least one of the conveyance speed in the registration section 346 and the conveyance speed in the fixing section 344 to correct the color misregistration.

Therefore, the color misregistration can be accurately corrected by adjusting the registration speed and/or the fixing speed.

In the image forming apparatus 1 according to the present embodiment, the controller (third controller 36) corrects color misregistration between at least two colors in the image formed on the sheet.

Therefore, it is possible to accurately correct the color misregistration between at least two colors in the image formed on the sheet.

In the image forming apparatus 1 according to the present embodiment, the controller (the third controller 36) measures the color misregistration amounts in the images formed on the at least one of the subsequent sheets. The controller adjusts at least one of the conveyance speed in the registration section 346 and the conveyance speed in the fixing section 344 to correct the color misregistration so that the measured color misregistration amount becomes smaller.

Therefore, by correcting the color misregistration based on the color misregistration amount in the image formed on the at least one of the subsequent sheets, the color misregistration in the image formed on the sheet can be corrected accurately.

In the image forming apparatus 1 according to the present embodiment, the reading section (image reading section 42) reads the images on the sheets continuously formed by the image forming section 34.

The controller (third controller 36) corrects the color misregistration based on a reading result obtained by reading the image formed on at least one of the subsequent sheets by the reading section.

Therefore, the reading section (image reading section 42) can omit the processing of determining the at least one of the subsequent sheets among the sheets on which images have been continuously formed by the image forming section 34.

In the image forming apparatus 1 according to the present embodiment, the reading section (image reading section 42) reads images formed on at least one of the subsequent sheets among the sheets on which images have been continuously formed by the image forming section 34.

The controller (third controller 36) corrects the color misregistration based on a reading result obtained by reading the image formed on at least one of the subsequent sheets by the reading section.

Therefore, the reading section (image reading section 42) can omit the process of reading the image on the first sheet which is unnecessary for the correction of the color misregistration.

In the image forming apparatus 1 according to the present embodiment, the controller (third controller 36) corrects color misregistration on the basis of a reading result obtained by reading an image formed on at least one of the subsequent sheets by the reading section (image reading section 42) before execution of a print job.

Therefore, the print job can be executed in the image forming apparatus 1 in a state where the color misregistration has been accurately corrected.

In the image forming apparatus 1 according to the present embodiment, the sheet is thick paper having a predetermined thickness or basis weight or more.

Therefore, even in a case where an image is formed on thick paper in which the color misregistration in the sheet conveyance direction (paper transport direction) is likely to occur, the color misregistration can be accurately corrected.

The image forming apparatus 1 according to the present embodiment includes the sensing section 22 that detects attribute information of a sheet.

The controller (third controller 36) corrects the color misregistration based on the attribute information of the sheet detected by the sensing section 22.

Therefore, it is possible to perform high accuracy color misregistration correction according to the attribute information of the sheet.

Although specific description has been given above based on the embodiment according to the present disclosure, the present disclosure is not limited to the above-described embodiment, and changes can be made without departing from the spirit and scope of the present disclosure.

For example, the image forming apparatus 1 may be configured to be able to transmit and receive information for mutual cooperation with a print controller (not illustrated) that performs print job generation, print management, and the like, another image forming system (not illustrated), a business management system, and the like.

In the present embodiment, the third controller 36 of the main body section 30 integrally controls the entire image forming apparatus 1, but the present invention is not limited thereto. A control device may be separately provided, and a controller of the control device may integrally control the entire image forming apparatus 1.

In addition, the detailed configuration of each device constituting the image forming apparatus 1 and the detailed operation of each device can also be appropriately modified without departing from the spirit and scope of the present disclosure.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
an image former that continuously forms images in a plurality of colors on sheets of paper by an intermediate transfer method;
a reader that reads an image that has been formed on a sheet of the paper by the image former; and
a hardware processor that corrects color misregistration in an image to be formed on a sheet of the paper by the image former, wherein
the hardware processor corrects the color misregistration based on a reading result obtained by reading, by the reader, an image that has been formed on at least one of a subsequent sheet among the sheets on which the images have been continuously formed by the image former, the subsequent sheet being subsequent to a first sheet among the sheets.

2. The image forming apparatus according to claim 1, wherein
the image former includes:
a registration section that conveys the sheets to a transfer section that transfers the images onto the sheets; and
a fixing section that fixes the images to the sheets, and
the hardware processor corrects the color misregistration by adjusting at least one of a conveyance speed in the registration section and a conveyance speed in the fixing section.

3. The image forming apparatus according to claim 1, wherein the hardware processor corrects the color misregistration between at least two colors in the image to be formed on the sheet.

4. The image forming apparatus according to claim 2, wherein the hardware processor measures a color misregistration amount in the image that has been formed on the at least one of the subsequent sheet, and adjusts the at least one of the conveyance speed in the registration section and the conveyance speed in the fixing section to correct the color misregistration such that the measured color misregistration amount becomes smaller.

5. The image forming apparatus according to claim 1, wherein
the reader reads the images on the sheets that have been continuously formed by the image former, and
the hardware processor corrects the color misregistration based on the reading result obtained by reading, by the reader, the image that has been formed on the at least one of the subsequent sheet.

6. The image forming apparatus according to claim 1, wherein
the reader reads the image that has been formed on the at least one of the subsequent sheet among the sheets on which the images have been continuously formed by the image former, and
the hardware processor corrects the color misregistration based on the reading result obtained by reading, by the reader, the image that has been formed on the at least one of the subsequent sheet.

7. The image forming apparatus according to claim 1, wherein the hardware processor corrects, before execution of a print job, the color misregistration based on the reading result obtained by reading, by the reader, the image that has been formed on the at least one of the subsequent sheet.

8. The image forming apparatus according to claim 1, wherein the paper is thick paper having a predetermined thickness or basis weight or more.

9. The image forming apparatus according to claim 1, further comprising
a sensor to detect attribute information of the paper, wherein the hardware processor corrects the color misregistration based on the attribute information detected by the sensor.

10. A non-transitory computer-readable storage medium storing a program for a computer of an image forming apparatus that includes: an image former that continuously form images in a plurality of colors on sheets of paper by an intermediate transfer method; and a reader that reads an image that has been formed on a sheet of the paper by the image former, the program causing the computer to function as
a hardware processor that corrects color misregistration in an image to be formed on a sheet of the paper by the image former, wherein
the hardware processor corrects the color misregistration based on a reading result of reading, by the reader, an image that has been formed on at least one of a subsequent sheet among the sheets on which the images have been continuously formed by the image former, the subsequent sheet being subsequent to a first sheet among the sheets.
